(19) United States
(12) Patent Application Publication
(10) Pub. No.: US 2010/0179673 A1
(43) Pub. Date: Jul. 15, 2010

(54) MULTITRACK RECORDER AND SYNCHRONOUS RECORDING METHOD USING A PLURALITY OF MULTITRACK RECORDERS

(75) Inventor: Yoshitaka MUROI, Tokyo (JP)

Correspondence Address: RABIN & Berdo, PC, 1101 14TH STREET, NW, SUITE 500, WASHINGTON, DC, 20005, US

(73) Assignee: Kabushiki Kaisha ZOOM, Tokyo (JP)

(21) Appl. No.: 12/686,738

(22) Filed: Jan. 13, 2010

(30) Foreign Application Priority Data
Jan. 14, 2009 (JP) 2009-006149

(51) Int. Cl. G06F 17/00; H04B 1/00; G06F 13/00

(52) U.S. Cl. 700/94; 381/119; 710/110

(57) ABSTRACT

Provided are a multitrack recorder and a synchronous recording method that are capable of exchanging a clock and a control message in synchronous recording using two multitrack recorders only by connecting therebetween by one signal line. The multitrack recorder capable of performing the synchronous recording between the two multitrack recorders (a master MTR (10) and a slave MTR (20)) by transmitting/receiving the packetized control message by USB communications corresponding to a bidirectional serial communication scheme includes: an SOF packet detecting section (14, 24) for detecting an SOF packet included in one of transmission data and reception data at predetermined periods; and an audio clock generating section (16, 26) for generating an audio clock that is synchronized with the SOF packet detected by the SOF packet detecting section (14, 24), and outputting the audio clock to a control section for controlling an operation of the multitrack recorder.

### BACKGROUND OF THE INVENTION

1. Field of the Invention

The present invention relates to a multitrack recorder provided with a plurality of tracks for musical recording, mixing, and mastering, and more particularly, to a multitrack recorder and a synchronous recording method that are capable of synchronous recording using a plurality of multitrack recorders.

2. Description of the Related Art

A multitrack recorder (MTR) provided with a plurality of tracks for musical recording, mixing, and mastering is in practical use. The multitrack recorder includes a large-scale device for professional use and a device for general use that is relatively small and inexpensive, the former being provided with, for example, 64 or more tracks, the latter being generally provided with 8 or 16 tracks. With the device for general use, to perform mixing or the like by using tracks the number of which exceeds the number of tracks provided to one multitrack recorder, two MTRs are connected to each other, which makes it necessary for the two MTRs to exchange a clock and a control message in addition to audio data. FIG. 8 is a schematic diagram illustrating a method for simultaneous recording using a plurality of conventional MTRs. A master MTR 100 and a slave MTR 200 are connected to each other by two unidirectional serial data transmission lines (UART OUT and UART IN) such as those in MIDI for exchanging the control message and by a signal line AUDIO CLK for exchanging the audio clock, thereby realizing synchronized operations of the two MTRs. At a time of synchronous recording, a LOCATE command is transmitted from the master MTR 100, the slave MTR 200 performs location, a PLAY command is transmitted from the master MTR 100, the master MTR 100 starts reproduction, and the slave MTR 200 starts reproduction. At this time, the clocks are synchronized, which prevents a loss of synchronization from occurring after that.

According to a conventional synchronous recording method, the master MTR 100 and the slave MTR 200 are connected to each other by the three signal lines, resulting in complicatedness. In addition, if the two MTRs are of different models, the audio clocks may be also different in frequency. Therefore, the synchronous recording may be impossible, an operation for bringing the frequencies into agreement with each other may become necessary, or the two MTRs may lose synchronization. It is possible to correct a loss of synchronization to some extent by using a time code or absolute address information on a storage medium (for example, JP 2007-265522 A) or by applying a special process to the audio data (for example, JP 8-153384 A), but sound quality is adversely affected, which is unpreferable.

### SUMMARY OF THE INVENTION

Therefore, an object of the present invention is to provide a multitrack recorder and a synchronous recording method that are capable of exchanging a clock and a control message in synchronous recording using two multitrack recorders only by connecting therebetween by one signal line.

Another object of the present invention is to provide a multitrack recorder capable of realizing synchronous recording superior in sound quality.

In order to achieve the above-mentioned objects, the present invention provides a multitrack recorder capable of performing synchronous recording by transmitting/receiving a packetized control message to/from another multitrack recorder by a bidirectional serial communication scheme, including: periodic packet detecting means for detecting a specific packet included in one of transmission data and reception data at predetermined periods; and audio clock generating means for generating an audio clock that is synchronized with the specific packet detected by the periodic packet detecting means, and outputting the audio clock to control means for controlling an operation of the multitrack recorder.

In the multitrack recorder according to the present invention, the multitrack recorder performs transmission/reception of the control message to/from another multitrack recorder by bidirectional serial communications. When the packetized control message is transmitted or received, the periodic packet detecting means detects the specific packet included in the transmission data or the reception data at predetermined periods. That is, the specific packet is detected from the transmission data if the multitrack recorder is a master device or from the reception data if the multitrack recorder is a slave device. The audio clock generating means generates the audio clock that is synchronized with the specific packet detected by the periodic packet detecting means, and outputs the audio clock to the control means for controlling the operation of the multitrack recorder.

Accordingly, the two multitrack recorders connected to each other by a bidirectional serial communication channel perform respective operations regarding reproduction and recording by using the audio clock based on the transmission data from the master device (that is, the reception data from the slave device). Note that audio data may also be multiplexed with the control message and transmitted/received by the bidirectional serial communications.

The multitrack recorder may be configured such that the audio clock generating means causes the audio clock to follow a predetermined target value of a frequency of the audio clock by calculating a deviation between the predetermined target value and an output value of the frequency of the audio clock output by the audio clock generating means. An SOF packet is included in, for example, a frame that conforms to such a bidirectional serial communication scheme as Universal Serial Bus (USB), and if two devices are connected to each other by USB, the frame is constantly transferred at periods of 0.125 msec (in USE 2.0, or 1 msec in USB 1.1) except for a suspended state. Accordingly, in USB, the period of the SOF is 0.125 msec (or 1 msec).

The audio clock generating means includes a voltage-controlled crystal oscillator (VCXO) for handling a small deviation and a phase-locked loop circuit (PLL) for handling a large deviation. The audio clock generating means is configured so that a threshold value T indicating which of the VCXO and the PLL is to handle a given deviation may be designed to have the following relationship with respect to an interval I of measurement/control:

I<(2·Fs)⁻¹/T

where Fs represents a sampling frequency.

Further, the VCXO may be subjected to PID control involving respective coefficients of:
a proportional gain P ranging from −0.6 to −0.1;
an integral gain I ranging from 0 to 0.2; and
a differential gain D ranging from −1 to 1.

Further, in order to achieve the above-mentioned objects, the present invention provides a synchronous recording method using a plurality of multitrack recorders, in which a slave multitrack recorder receives a packetized control message by a bidirectional serial communication scheme when a master multitrack recorder performs synchronous recording, including: a periodic packet detecting step of detecting, by each of the master multitrack recorder and the slave multitrack recorder, a specific packet included at predetermined periods in transmission data transmitted by the master multitrack recorder to the slave multitrack recorder and reception data received by the slave multitrack recorder from the master multitrack recorder; and an audio clock generating step of generating, by each of the master multitrack recorder and the slave multitrack recorder, an audio clock that is synchronized with the specific packet detected in the periodic packet detecting step, and outputting the audio clock to control means for controlling an operation of each of the master multitrack recorder and the slave multitrack recorder itself.

According to the multitrack recorder and the synchronous recording method by using the plurality of multitrack recorders according to the present invention, it is possible to exchange the clock and the control message in the synchronous recording using the two multitrack recorders only by connecting therebetween by one signal line. Accordingly, it is possible to reduce the number of signal lines that connect the multitrack recorders to each other. Further, the configuration causes the audio clock to follow the SOF packet by calculating the deviation between the period of the SOF packet detected by the periodic packet detecting means and the period of the audio clock output by the audio clock generating means, to thereby prevent a jitter of the SOF from adversely affecting the sound quality. Further, the audio clock generating means includes the VCXO and the PLL, and by limiting the threshold value T indicating which is to handle the deviation and the respective gain values for the PID control of the VCXO, it is possible to perform the synchronous recording while suppressing an adverse influence on the sound quality to a minimum.

### BRIEF DESCRIPTION OF THE DRAWINGS

In the accompanying drawings:

FIG. 1 is a circuit block diagram illustrating a configuration of a state in which two multitrack recorders according to an embodiment of the present invention are connected to each other for synchronous recording;

FIG. 2 is a diagram illustrating a structure of a transfer data that conforms to a communication protocol of USB;

FIG. 3 is a diagram illustrating a more detailed configuration of an audio clock generating section of the multitrack recorders illustrated in FIG. 1;

FIG. 4 is a graph illustrating which of a PLL and a VCXO is to handle a deviation in the audio clock generating section of FIG. 3;

FIG. 5 is a diagram illustrating states in which the PLL and the VCXO handle a deviation in the audio clock generating section of FIG. 3;

FIG. 6 is a flowchart illustrating a flow of a setting state of the PLL of FIG. 3;

FIG. 7 is a flowchart illustrating a flow of a setting state of the VCXO of FIG. 3; and

FIG. 8 is a circuit block diagram illustrating a configuration of a state in which two conventional multitrack recorders are connected to each other for synchronous recording.

### DETAILED DESCRIPTION OF THE PREFERRED EMBODIMENT

Hereinafter, description is made of a multitrack recorder and a synchronous recording method using a plurality of multitrack recorders according to an embodiment of the present invention. Note that the following description is not made to limit the scope of the appended claims but made for a better understanding of the present invention.

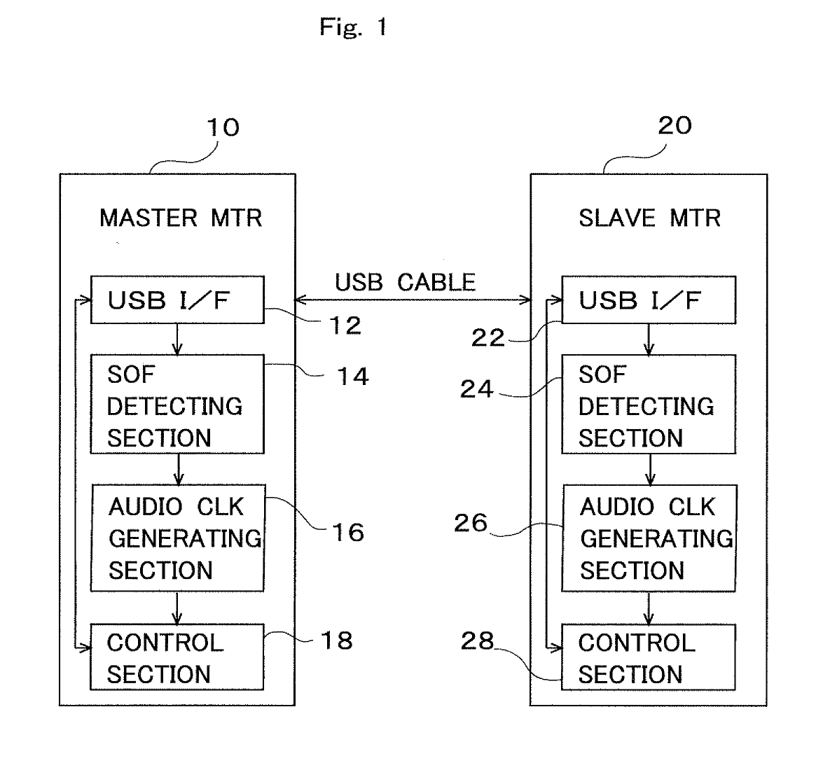

FIG. 1 illustrates a primary configuration of multitrack recorders according to the embodiment of the present invention, omitting a portion that is not directly related to the present invention. In FIG. 1, the two multitrack recorders are of the same kind, a master MTR 10 and a slave MTR 20 include USB interfaces 12 and 22, SOF detecting sections 14 and 24, audio clock generating sections 16 and 26, and control sections 18 and 28, respectively. Hereinafter, description is made of respective functions and operations of the master MTR 10 and the slave MTR 20, but the master MTR 10 and the slave MTR 20 are of the same kind, and hence it should be noted that the standpoints of the master device and the slave device are interchangeable.

The USB interface 12 receives data from the control section 18 for controlling the operation of the MTR, converts the data into transmission data having a format that conforms to the USB communication protocol 2.0, and transmits the transmission data to another device via a USB cable. Meanwhile, the USB interface 12 converts reception data conforming to the USB communication protocol that has been transmitted via the USB cable into data having a format suitable for the control section 18, and sends the data to the control section 18. Thus, bidirectional serial communications conforming to the USB communication protocol 2.0 are performed. However, in a case where the slave multitrack recorder connected to the master MTR 10 does not conform to USB 2.0, bidirectional serial communications conforming to USB 1.0 may also be performed. In that case, the period of an SOF packet described below is 1 msec. In the case of the synchronous recording, the USB interface 12 of the master MTR 10 receives a control message from the control section 18, packetizes the control message so as to conform to the USE communication protocol, and generates the transmission data. In contrast, the USB interface 22 of the slave MTR 20 detects the packetized control message from the reception data, and sends the control message to the control section 28. Examples of the control message include PLAY (reproduction), STOP (stopping), PAUSE (pausing), and LOCATE (movement to a specified time).

The SOF detecting section 14 of the master MTR 10 receives an input of the transmission data transmitted by the USE interface 12, and detects a specific packet included in the transmission data at predetermined periods. Meanwhile, the SOF detecting section 24 of the slave MTR 20 detects the specific packet included at the predetermined periods in the reception data received by the USE interface 22. The specific packet included at the predetermined periods is a start-of-frame (SOF) packet that indicates the start of data transmitted/received on a frame basis according to the USB communication protocol.

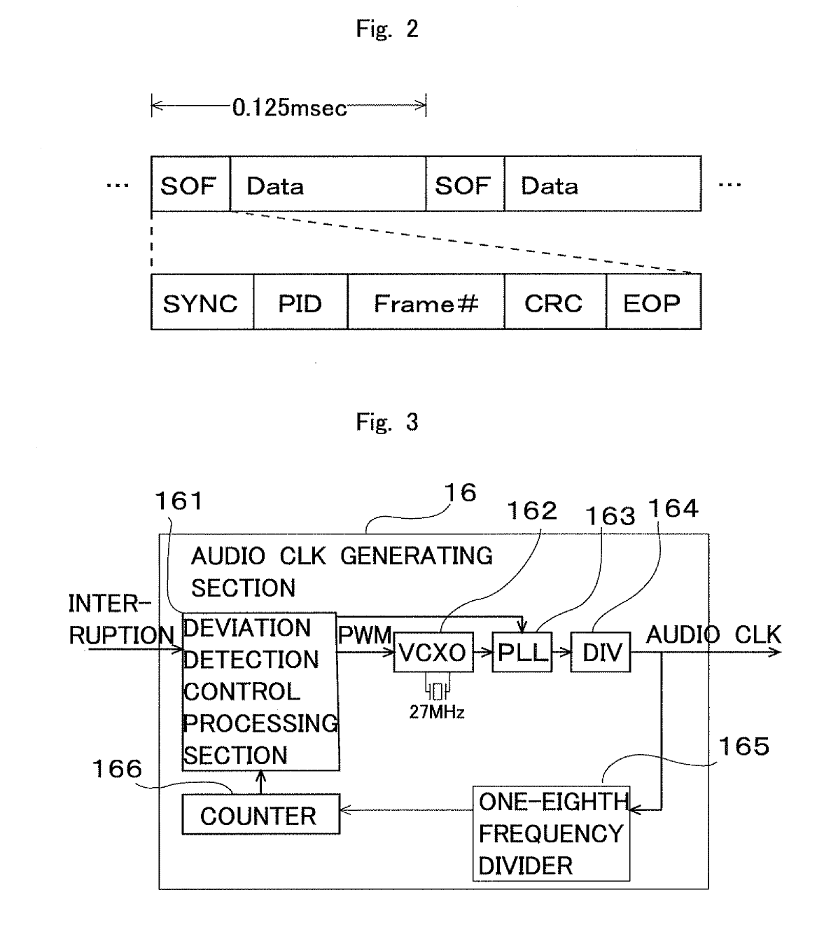

As illustrated in FIG. 2, data is transmitted/received on a frame basis, the frame being composed of the SOF packet and the data, and the period of each frame is 0.125 msec. Each frame starts with the SOF packet, and hence the SOF packet is included in the transmission data and the reception data at the periods of 0.125 msec. The SOF packet is composed of SYNC data for achieving synchronization, PID data that indicates a type of packet, Frame# data, check code data, and end-of-packet data, and the PID of the SOF packet is defined as “0101”. The SOF detecting section 14 outputs an interruption each time the SOF is detected in 0.125 msec.

The audio clock generating section 16 generates an audio clock based on the interruption input from the SOF detecting section 14. That is, in synchronization with a timing of the interruption input every 0.125 msec, the audio clock generating section 16 generates the audio clock having a predetermined frequency, and sends the audio clock to the control section 18 for controlling the operation of the multitrack recorder. In the multitrack recorders according to this embodiment, the frequency of the audio clock is 22.5792 MHz, 24.576 MHz, 12 MHz, or 24 MHz.

As described above, the multitrack recorders according to this embodiment are connected to each other by a bidirectional serial communication channel, and perform the respective operations regarding reproduction and recording by using the audio clock based on the transmission data from the master MTR 10 (that is, the reception data from the slave MTR 20). Accordingly, it is possible to transmit/receive the clock and the control message that are multiplexed by one transmission channel, which may reduce the number of signal lines that connect the multitrack recorders to each other. In the multitrack recorders according to this embodiment, audio data is transmitted/received by using another signal line, and hence the synchronous recording becomes possible by connecting the multitrack recorders by two signal lines. In another embodiment of the present invention, the audio data is also multiplexed with the control message and transmitted/received by the bidirectional serial communications, and hence one signal line suffices to connect the multitrack recorders to each other.

In the embodiment illustrated in FIG. 1, the audio clock generating section 16 is configured to cause the audio clock to follow the SOF packet by calculating a deviation between a predetermined target value of the frequency of the audio clock and an output value of the frequency of the audio clock output by the audio clock generating section.

In FIG. 3, the audio clock generating section 16 includes a deviation detection control processing section 161, a VCXO 162, a PLL 163, a frequency divider 164, a one-eighth frequency divider 165, and a counter 166.

The deviation detection control processing section 161 detects a deviation e between a theoretical count value determined by the predetermined target value of the frequency of the audio clock and a measurement count value measured by the counter 166 at a timing of the interruption input from the SOF detecting section 14, and changes settings of the VCXO 162 or the PLL 163 according to a magnitude of the deviation e. The VCXO 162 and the PLL 163 output a clock having a frequency adjusted based on a signal sent from the deviation detection control processing section 161. The frequency divider 164 divides the frequency of the clock output from the PLL 163, generates the audio clock having the predetermined frequency, and outputs the audio clock to the control section 18. The one-eighth frequency divider 165 divides the audio clock output from the frequency divider 164 to have an appropriate frequency, and the counter 166 measures the clock output from the one-eighth frequency divider 165, and feeds the measurement count value back to the deviation detection control processing section 161.

By thus causing the frequency of the audio clock to follow the target value under feedback control, it is possible to prevent a jitter of the SOF from adversely affecting sound quality.

Further, the multitrack recorder according to this embodiment is configured to obtain superior sound quality by using the VCXO 162 and the PLL 163 in combination to perform correction of the clock.

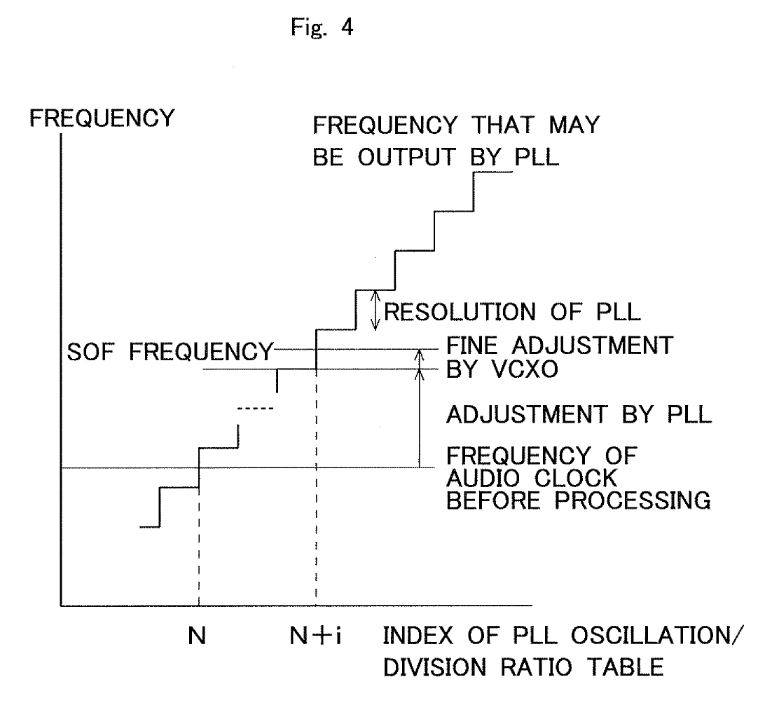

The VCXO 162 and the PLL 163 are selectively used depending on the magnitude of the deviation. That is, the VCXO 162 and the PLL 163 are configured to handle a small deviation and a large deviation, respectively. The jitter of SOF is determined as ±500 ppm by the USB specification. This makes it necessary to follow a change of at least approximately ±1000 ppm. In addition, the general VCXO has a range of change of approximately ±100 ppm, which is narrower than the PLL, while the PLL has a higher resolution in frequency that maybe output. Therefore, as illustrated in FIG. 4, the configuration causes the deviation to be handled by changing the setting of the PLL 163 if a large change is necessary, and to be handled by using the VCXO 162 for a small change.

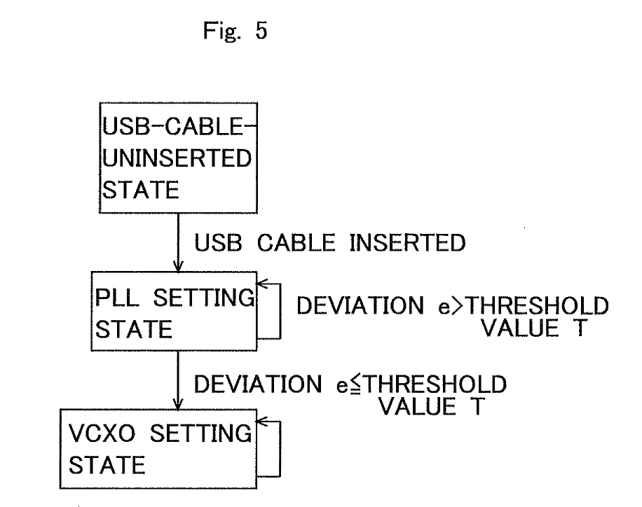

In FIG. 4, the longitudinal axis represents the frequency (Hz), and the horizontal axis represents an index of an oscillation/division ratio table of the PLL 163 that is prestored in the deviation detection control processing section 161. The PLL 163 has a relatively high resolution in frequency, and therefore oscillates a predetermined frequency expressed as a stepwise graph according to the index of the table. FIG. 5 illustrates three states of the audio clock generating section 16 for achieving synchronization between the SOF packet and the audio clock. That is, the three states are a USB-cable-uninserted state, a PLL setting state, and a VCXO setting state.

According to the USB communication protocol, immediately after the two devices with the power on are connected to each other by the USB cable, communications are started therebetween. Therefore, if the USB cable is inserted between the master MTR 10 and the slave MTR 20, data is exchanged irrespective of an operation state of each of the MTRs, and the audio clock becomes ready to be generated.

A threshold value T indicating which of the VCXO 162 and the PLL 163 is to handle the deviation is determined by the resolution of the PLL 163 as illustrated in FIG. 4, and theoretically has a lower limit of half the resolution of the PLL, but the resolution of the PLL 163 may be set as the threshold value T as it is The PLL 163 is designed so that the threshold value T has the following relationship with respect to an interval I of measurement/control:

I<(2·Fs)⁻¹/T

where Fs represents a sampling frequency. The threshold value T is set in the deviation detection control processing section 161. This is based on an idea that compensating for the jitter assumed under the VCXO control at the measurement/control intervals suffices on the presumption that “a loss in synchronization” means “a lack of one audio sample”. According to this idea, the measurement/control interval may be set to be long, which produces such a merit that the ranges of a control amount and a jitter become narrow. In this embodiment, the interval of measurement/control is set to 100 msec, and the threshold value T is set to 16 ppm.

As illustrated in FIGS. 4 and 5, the PLL setting state is started immediately after the USB cable is inserted, and the setting is repeatedly performed on the PLL until the deviation between the frequency of the audio clock before the processing and the frequency of the SOF becomes equal to or smaller than the threshold value T. If the deviation becomes equal to or smaller than the threshold value T, the VCXO setting state is started to perform fine adjustment of the deviation.

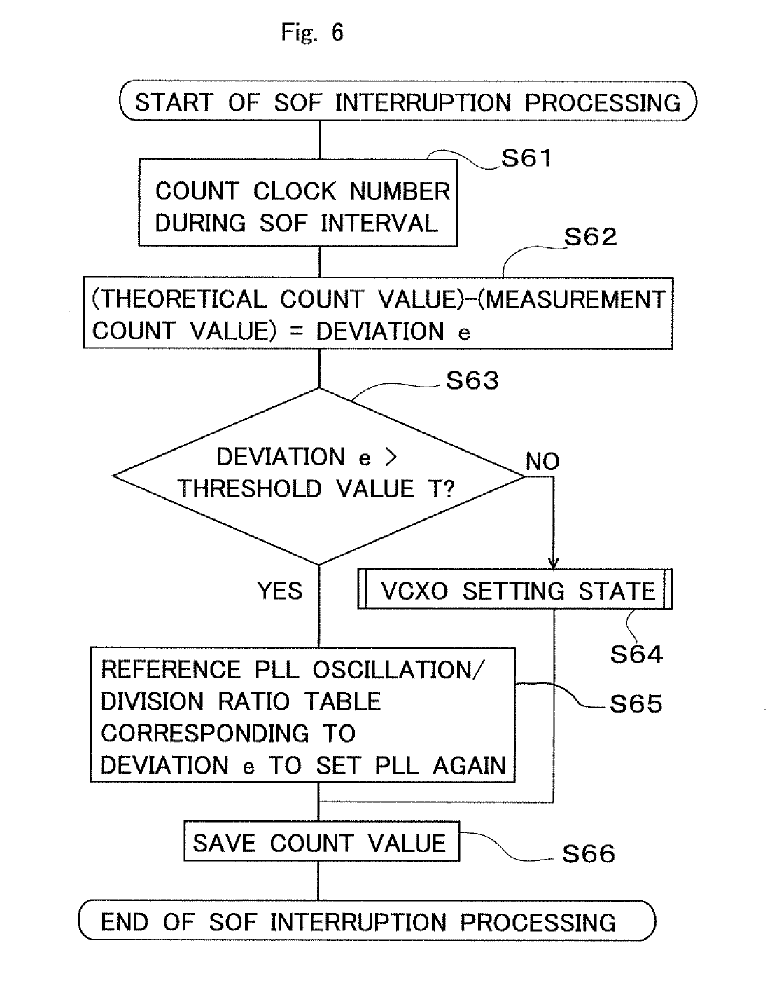

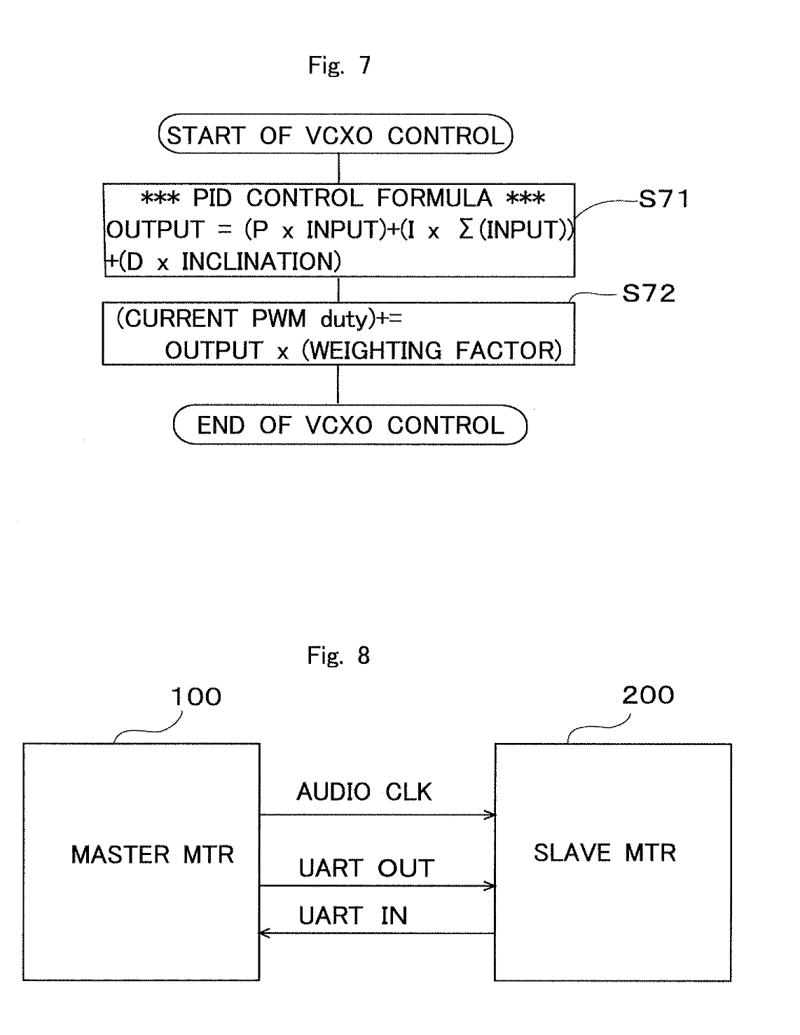

FIG. 6 illustrates a flow of a processing for the PLL setting state. When an SOF interruption processing is started, the deviation detection control processing section 161 measures the count value by the counter 166 during the interval of the SOF input from the SOF detecting section 14 (Step S61). Subsequently, the deviation detection control processing section 161 obtains the deviation e between the theoretical count value based on the predetermined frequency of the audio clock and the measurement count value input from the counter 166 (Step S62), and compares the deviation e with the threshold value T (Step S63). If the deviation e is equal to or smaller than the threshold value T, the state shifts to the VCXO setting state of FIG. 7 (Step S64), while if the deviation e is larger than the threshold value T, the PLL oscillation/division ratio table corresponding to the deviation e is referenced to set the PLL again (Step S65). That is, as illustrated in FIG. 4, the index of the PLL oscillation/division ratio table is set to N for the frequency of the audio clock before the processing, but is again set to N+i after the adjustment by PLL. Thus, the frequency of the audio clock before the processing becomes closer to an ideal SOF frequency in a case where the audio clock is synchronized with the SOF packet. The measured count value is saved (Step S66).

FIG. 7 illustrates a flow of a processing for the VCXO setting state. As illustrated in FIG. 5, if the deviation e is equal to or smaller than the threshold value T, the state shifts from the PLL setting state to the VCXO setting state. The VCXO 162 is subjected to PID control by the deviation detection control processing section 161. That is, if the deviation e is input, a calculation is performed by “output=(P×input)+(I×Σ(input))+(D×inclination)” (Step S71). In this embodiment, the respective coefficients are determined as a proportional gain P=−0.4, an integral gain I=0.01, and a differential gain D=0.05. The respective coefficients are preferably determined within the range of the proportional gain P=−0.6 to −0.1, the integral gain I=0 to 0.2, and the differential gain D=−1 to 1 in order to suppress the influence of the jitter to a minimum. The calculated output is multiplied by a weighting factor and added to a current PWM output to the VCXO 162, and is PWM-output from the deviation detection control processing section 161 to the VCXO 162 (Step S72). The VCXO 162 is set again based on the PWM output, and fine adjustment is performed on the frequency of the audio clock.

By such a procedure as described above performed every 100 msec, the frequency of the audio clock before the processing illustrated in FIG. 4 becomes close to the ideal SOF frequency, which may eliminate the adverse influence of the jitter of the SOF packet or suppress the adverse influence to a minimum. By using the measurement/control interval, the threshold value T, and the coefficients of the PID control described above to perform the feedback control, even if there occurs a deviation between the frequency of the audio clock that is actually output and the predetermined frequency of the audio clock, it is possible to achieve convergence without an abrupt change in the output. It has turned out empirically that a satisfactory frequency characteristic is obtained particularly obviously by suppressing the change to a small amount even if a time until the convergence is achieved becomes long.

As described above, according to the multitrack recorders according to this embodiment and the synchronous recording method using the plurality of multitrack recorders, it is possible to exchange the clock and the control message in the synchronous recording using the two multitrack recorders only by connecting therebetween by one signal line. Accordingly, it is possible to reduce the number of signal lines that connect the multitrack recorders to each other.

The embodiment of the present invention has been described above, but the present invention is not limited to the above-mentioned embodiment, and modifications may naturally be made appropriately within the scope of the gist of the present invention.

What is claimed is:

1. A multitrack recorder capable of performing synchronous recording by transmitting/receiving a packetized control message to/from another multitrack recorder by a bidirectional serial communication scheme, comprising:
periodic packet detecting means for detecting a specific packet included in one of transmission data and reception data at predetermined periods; and
audio clock generating means for generating an audio clock that is synchronized with the specific packet detected by the periodic packet detecting means, and outputting the audio clock to control means for controlling an operation of the multitrack recorder.

2. A multitrack recorder according to claim 1, wherein the audio clock generating means causes the audio clock to follow a predetermined target value of a frequency of the audio clock by calculating a deviation between the predetermined target value and an output value of the frequency of the audio clock output by the audio clock generating means.

3. A multitrack recorder according to claim 2, wherein:
the audio clock generating means includes a voltage-controlled crystal oscillator (VCXO) for handling a small deviation, and a phase-locked loop circuit (PLL) for handling a large deviation; and
the audio clock generating means is configured so that a threshold value T indicating which of the VCXO and the PLL is to handle a given deviation has the following relationship with respect to an interval I of measurement/control:
I<(2·Fs)⁻¹/T
where Fs represents a sampling frequency.

4. A multitrack recorder according to claim 3, wherein the VCXO is subjected to PID control involving respective coefficients of:
a proportional gain P ranging from −0.6 to −0.1;
an integral gain I ranging from 0 to 0.2; and
a differential gain D ranging from −1 to 1.

5. A synchronous recording method using a plurality of multitrack recorders, in which a slave multitrack recorder receives a packetized control message by a bidirectional serial communication scheme when a master multitrack recorder performs synchronous recording, comprising:
a periodic packet detecting step of detecting, by each of the master multitrack recorder and the slave multitrack recorder, a specific packet included at predetermined periods in transmission data transmitted by the master multitrack recorder to the slave multitrack recorder and reception data received by the slave multitrack recorder from the master multitrack recorder; and
an audio clock generating step of generating, by each of the master multitrack recorder and the slave multitrack recorder, an audio clock that is synchronized with the specific packet detected in the periodic packet detecting step, and outputting the audio clock to control means for controlling an operation of each of the master multitrack recorder and the slave multitrack recorder itself.
